(19) United States
(12) Patent Application Publication
(10) Pub. No.: US 2002/0143827 A1
(43) Pub. Date: Oct. 3, 2002

(54) Document intelligence censor

(76) Inventor: John Christopher Crandall, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 09/822,152

(22) Filed: Mar. 30, 2001

(51) Int. Cl. G06F 17/21; G06F 17/24

(52) U.S. Cl. 707/530; 707/526

(57) ABSTRACT

The invention discloses a system and method for censoring documents of release-sensitive information. The system preferably uses a censor database of restricted or sensitive terms to filter a document for occurrences of the restricted terms. When such restricted terms are found in the document, they are highlighted or marked to preferably draw the user's attention. A second database of alternate non-restricted terms, which correspond to the restricted terms, is preferably used to offer non-restricted terms to replace the restricted ones. Both databases are preferably customizable by users, and may also preferably include access restrictions in order to ensure the accuracy of the censor terms as well as the alternative non-restricted terms.

### BACKGROUND

Competing corporations generally strive to incorporate unique features or products into their repertoire of products and/or services in order to make their products and services stand out from the rest. It is therefore advantageous for competing corporations to research competitors to find out what different features or elements the competitor is planning to incorporate in order to keep up with the products and/or services in any particular industry.

Aside from information obtained illegally through covert corporate espionage, many corporations sometimes inadvertently leak a considerable amount of sensitive information regarding products and/or services through seemingly innocuous publications. Job postings, which are generally freely available to the public, may inadvertently contain information that could become a road map for a competing company to “figure out” what another company is doing. For example, a wheelchair company determines that it wants to incorporate built-in wireless communications and assistance systems, such as those beginning to be seen more prevalently on luxury cars, into its latest line of high-end wheelchairs. The wheelchair company begins posting employment requisitions for persons skilled in wireless communications including wireless telephony and wireless telemetry systems. A competing wheelchair company may obtain copies of such requisitions and deduce that the first wheelchair company is planning to incorporate a wireless assistance system into its wheelchairs. The competing wheelchair company could then begin developing its own systems into its wheelchairs. This information would, most likely, have been released by a human resource professional, who did not appreciate the sensitivity of the information.

Such sensitive information may generally be found in other public release documents or job postings from any number of other industries or technologies. The problem may generally arise from corporate-published documents written by persons who do not have an appreciation for the sensitivity of the information, whether they are administrative, technical, or business people.

Furthermore, while high-profile documents, such as Securities Exchange Commission (SEC) reports, released by companies will typically be reviewed for inadvertent release of sensitive information, other low-profile documents may not be given such review.

There are currently no applications other than simple human review to search and censor a document for a list of sensitive terms. There are applications within typical word processing programs to perform a “Find” or “Search,” in addition to a “Replace” function which enables a user to find a specified single term and replace it with another specified single term. However, these “Find-and-Replace” utilities do not allow a simultaneous search for a group of targeted terms.

Other utilities, such as spell checkers, thesauri, and grammar checkers, will generally review a document based on a database of words and rules, and may also offer corrections to the highlighted information. However, such utilities are based on universal relationships and terminology, and not on the impact that the word's content may have.

### SUMMARY OF THE INVENTION

It would therefore be advantageous to have a censoring system that reviews documents for selected sensitive terminology. Such a system may also provide generalized alternative terminology in order to accomplish the purpose of the sensitive terms without revealing the sensitive information.

The present invention is directed to a computerized system and method for a document censor. A preferred embodiment of the present invention may incorporate a censor database of restricted terms and a text comparator for preferably finding ones of the restricted terms in the document. For the restricted terms that are found, a text highlighter would then highlight the restricted terms found in the document. The censor system may also preferably comprise a generalization database of non-restricted terms which correspond to the restricted terms. Thus each restricted term may have one or more corresponding non-restricted terms. The generalization database may be preferably used to substitute non-restricted terms for restricted ones.

The preferred method of the present invention provides preferably filtering the document to find any of the prohibited expressions, and then visibly marking any of the prohibited expressions found in the document. Potential alternate expressions may preferably be grouped according to corresponding prohibited expressions and presented to any users. Therefore, as expressions from the list of prohibited expressions are found in the document through the directed filtering, the user may preferably be presented with a group of related alternate expressions corresponding to the prohibited expressions, but that do not reveal the specific sensitive information contained therein.

The databases of the preferred embodiment system may preferably be user-customizable to build an industry-specific database of censor terms as well as corresponding acceptable alternatives.

### BRIEF DESCRIPTION OF THE DRAWING

FIG. 1 is a high-level block diagram illustrating a preferred embodiment of the present invention;

FIG. 2 is a schematic diagram illustrating a preferred embodiment of the present invention;

FIG. 3 is a schematic diagram illustrating a preferred embodiment of the present invention configured in a windows-styled computer system with an additional pop-up option menu;

FIG. 4 is a schematic diagram illustrating a preferred embodiment of the present invention showing a centralized censoring system accessible by remote users; and

FIG. 5 is a flow chart illustrating the steps for implementing a preferred embodiment of the present invention.

### DETAILED DESCRIPTION

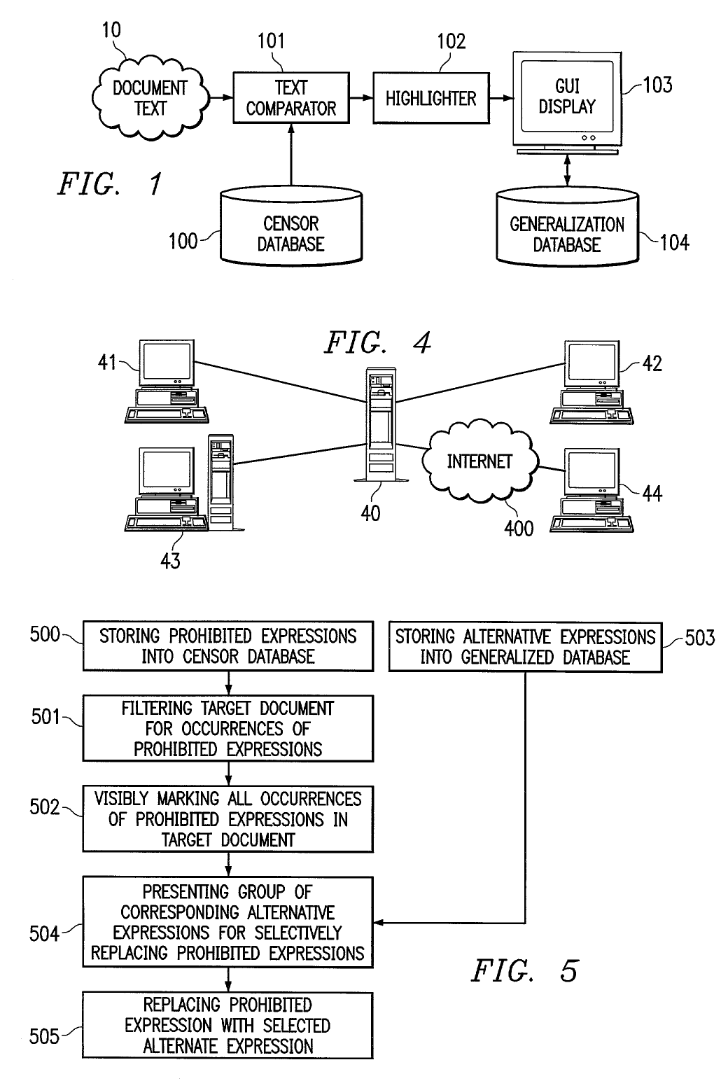

FIG. 1 illustrates the basic functional blocks of a preferred embodiment of the present invention. The system preferably uses censor database 100 as the basis for filtering document text 10. The filtering preferably takes place in text comparator 101. Prohibited or sensitive terms stored in censor database 100 are compared against document text 10 to find exact and variation matches. As the inventive system finds the prohibited or sensitive terms in document text 10, those terms are preferably highlighted by highlighter 102. The highlighting mechanism visibly draws a user's attention to the sensitive terms at graphical user interface (GUI) display 103.

In the described preferred embodiment, the censor system may preferably further interact with the user to find acceptable replacement terms which are not prohibited or not sensitive to release. Such alternate terms are stored in generalization database 104 and preferably have a correlation to the sensitive terms in censor database 100. For example, the sensitive or prohibited term may be “low-noise amplification.” The corresponding alternate terms may include “radio frequency (RF) signal processing,” “analog electronics,” “audio electronics,” and/or “video electronics.” Therefore, the alternate terms preferably cover the general topic of the prohibited or restricted term. They may also preferably correspond to other prohibited or sensitive terms. Using the above-example alternate terms, another prohibited term could be “RF tuner.” “RF tuner” would likely also have the alternate terms of “radio frequency (RF) signal processing,” “analog electronics,” “audio electronics,” and/or “video electronics.” It may have additional alternative terms, but would generally share many of the same generalized terms with “low-noise amplification.”

The preferred embodiment of the present invention may then preferably offer choices from generalization database 104 to the user for replacing the highlighted prohibited terms in document text 10.

In order to provide adequate censoring, censor database 100 is preferably customizable for each user or industry in which the system is used. Thus, while companies involved in cellular electronics would benefit from careful censoring of publications as much as companies involved in developing prescription drugs, the lists of prohibited or sensitive terms will typically be completely different. The users may, therefore, preferably initialize the inventive system by entering groups of sensitive terms into censor database 100.

It should be noted that while customization is an important feature of the present invention, alternative embodiments may be distributed to particular industries with a base number of predefined sensitive terms common to such industries. In such embodiments, the developer of the inventive system may preferably load different sets of “sensitive” data into censor database 100 depending on the destination industry of the particular system. Once received and installed at the destination, the customization feature would preferably allow the actual users to modify, add, or delete terms from the prohibited lists.

Similarly, generalization database 104 may begin by incorporating a thesaurus-type application to aid in developing the list of alternative words. As the system alerts the user to the prohibited term, it may preferably offer alternatives from the thesaurus as well as offering the user the option to generate his or her own alternative. As the thesaurus alternatives and user-generated alternatives are chosen, the preferred embodiment of the present invention will preferably begin forming correlations and associations between the user-defined and thesaurus-generated non-prohibited terms and adding those to generalization database 104. Therefore, as the user uses the preferred embodiment of the present invention, both censor database 100 and generalization database 104 begin to grow larger, preferably offering an increasingly wider variety of alternates in addition to restricting many more sensitive terms.

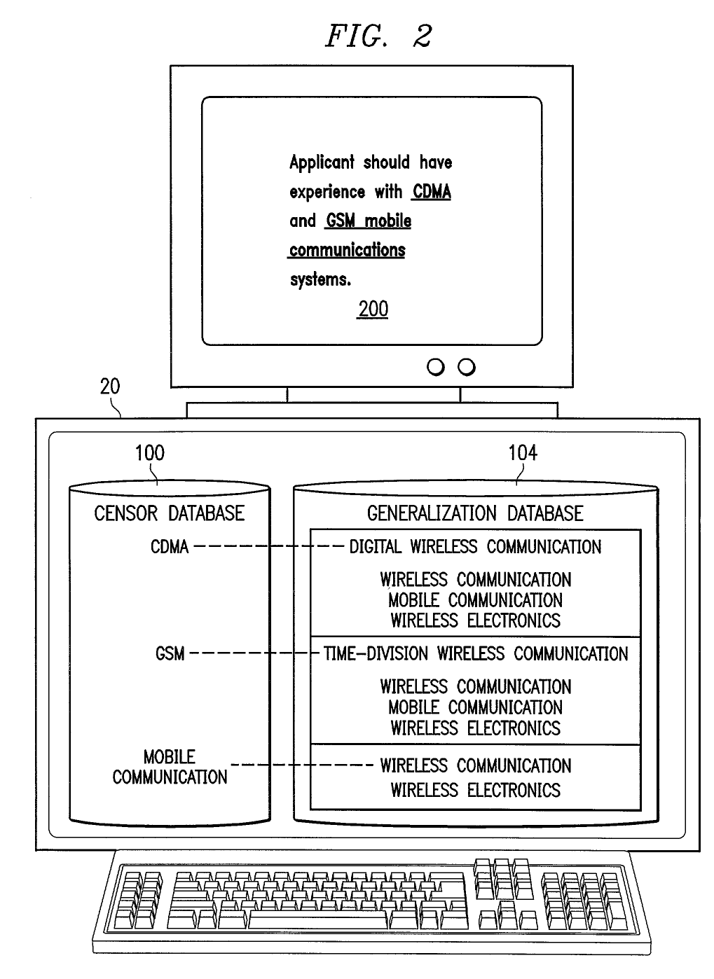

FIG. 2 illustrates an alternative, preferred embodiment of the present invention. Computer 20 includes a censor application configured according to the preferred embodiment of the present invention. As the inventive censor application filters the document, it preferably accesses censor database 100 either resident on computer 20 or on a remote storage device or computer. Monitor 200 displays the document text as filtered by the censor application. As noted in FIG. 2, censor database 100 includes the terms “CDMA,” “GSM,” and “Mobile Communication.” These terms are preferably highlighted in monitor 200 to indicate to the user the prohibited or restricted terms contained in the document.

The document censor of the preferred embodiment may also preferably include generalization database 104 to assist the user in finding acceptable alternative terms. Several different methods may preferably be incorporated to implement the assisted replacement. In a first option, the highlighting placed by the censor may also preferably include hypertext functionality, such that as a user clicks or selects the particular highlighted text (e.g., “CDMA” as shown on monitor 200), a list of the corresponding non-restricted terms preferably pops up or is detailed on a menu or dialog box. By selecting or clicking on one of the alternate terms, the user may then preferably replace the restricted term with the desired alternate.

A second option would preferably incorporate roll-over functionality. In this second option, as a user passes the cursor over the highlighted text, a box preferably pops up including the alternate, non-restricted terms. Similar to the first option, the user may preferably select the desired alterative term from the pop up list in order to replace the sensitive or prohibited expression.

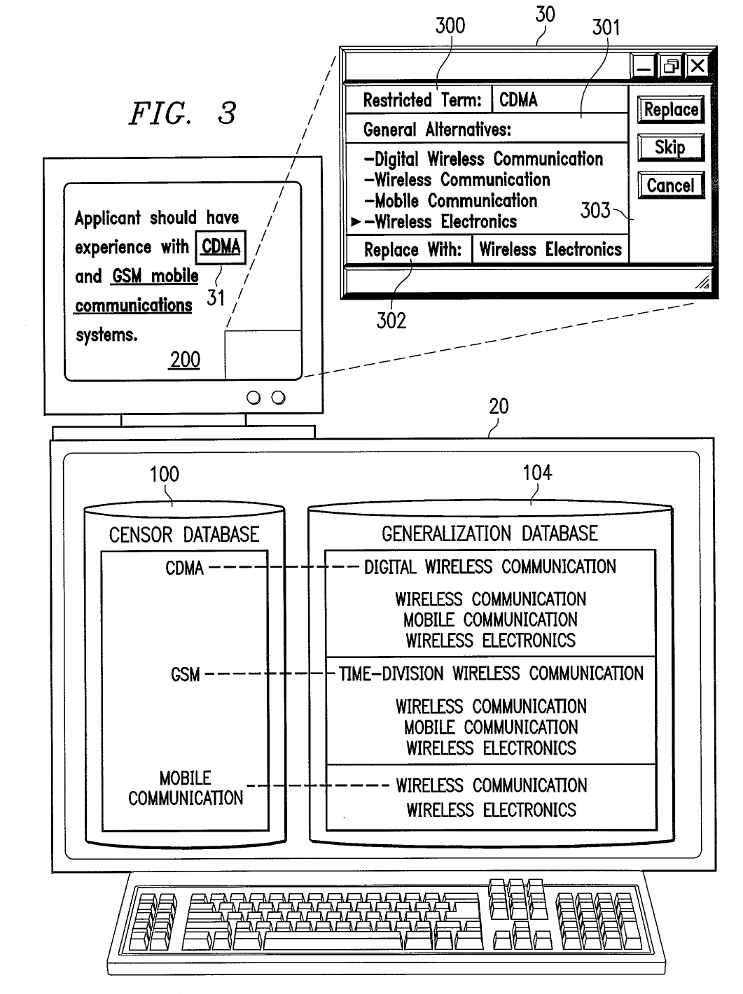

The alternative, preferred embodiment shown in FIG. 3 includes a third option for replacing restricted terms with alternate, non-restricted terms. The user may preferably access censor database 100 and generalization database 104 through computer 20 in drafting or writing a text document. In the alternative embodiment of FIG. 3, the inventive document censor may preferably be a utility that is a part of a larger application, in a similar manner as spell checkers and grammar checkers are utilities in word processing applications. The user may preferably choose to run the censor on the target document. The censor utility preferably highlights every occurrence of the restricted terms listed in censor database 100.

In the replacement phase, dialog box 30 preferably pops up to guide the user through the process of selecting alternate terms. The inventive censor would preferably move from highlighted term to highlighted term prompting the user for some sort of replacement action or inaction. The active highlighted term would preferably be highlighted in a different aspect, as shown with highlight box 31 around the highlighted term “CDMA,” in order to show the user which term is active. The active restricted expression would also preferably be shown in Restricted Term field 300 of dialog box 30. The user would then preferably be presented with a list of non-restricted alternatives in Generalized Alternatives field 301. The user may then preferably select one of the alternates in field 301 or enter his or her own generalized alternative in Replace With field 302. To make the replacement, the user would preferably actuate the “Replace” button in button field 303. Button field 303 also contains the “Skip” button, which makes the inventive censor skip to the next highlighted term, and the “Cancel” button, which closes the inventive censor utility and returns to the document text editor or word processor, but preferably maintains the highlighting of the sensitive terms placed by the inventive document censor.

The inventive document censor may preferably be used on a stand-alone computer or may be configured as a part of a network. FIG. 4 illustrates an alternative embodiment of the present invention configured for use in a network. Central network server 40 preferably houses the inventive document censor and both the database of restricted terms as well as the database of corresponding alternate terms. The central location of the databases preferably allows many different users to access and use the document censor. For example, user 41 may work in the human resources (HR) office at the company. HR user 41 would then preferably use the document censor on central network server 40 to censor employment-related documents. User 42 may work in the accounting division. Accounting user 42 may then preferably use the document censor on central server 40 to censor financial documents. User 43 may work in the engineering section of the company. Engineering user 43 may then preferably use the document censor on central server 40 to preferably censor engineering specifications or other technical documents.

If the example company allowed access to its network over Internet 400, user 44 could preferably use the document censor on central network server 40 while working at home or on the road. This may allow user 44 to censor personal documents, such as scholarly articles or industry presentations.

In the network configuration shown in FIG. 4, it may be desirable to control the editing of the databases of restricted terms and alternate terms. In such an alternative embodiment, there may preferably be two modes of access to the inventive censor system. For normal use, without authority to edit the databases, a user mode may be allowed for all regular users. Using the diagram of FIG. 4 again, users 41, 42, and 44 may preferably be restricted to only a user mode and, therefore, not allowed to edit or modify either of the inventive censor system databases on central network server 40. User 43 may preferably be given administrative access to the inventive document censor. With administrative authority, user 43 would preferably be able to affect changes in both databases. Therefore, the list of restricted terms may be determined by a knowledgeable person, group, and/or committee. Once these sensitive or prohibited expressions were agreed to, user 43 would preferably enter them into the database of censor terms. The corresponding list of alternate terms could preferably be generated in a similar manner. The “censor” group or person could decide on the most appropriate alternate, non-sensitive expressions to use for each of the censored terms. Again, user 43 would preferably be able to enter those alternate expressions into the second database and associate them with the appropriate corresponding censor terms. Users 41, 42, and 44 could then preferably access the document censor and its databases on central network server 40 to perform any necessary censoring without risking that improper censor terms or alternate terms were added to the system.

When implemented in software, the elements of the present invention are essentially the code segments to perform the necessary tasks. The program or code segments can be stored in a processor readable medium or transmitted by a computer data signal embodied in a carrier wave, or a signal modulated by a carrier, over a transmission medium. The “processor readable medium” may include any medium that can store or transfer information. Examples of the processor readable medium include an electronic circuit, a semiconductor memory device, a ROM, a flash memory, an erasable ROM (EROM), a floppy diskette, a compact disk CD-ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc.

It should be noted that in alternative embodiments of the present invention each user may preferably build a local database of alternate expressions. Thus, if editing of the alternate database is restricted, the individual users with only user mode access, could preferably generate their own additional lists of alternatives. Such embodiments may be useful in situations where the individuals with user mode access are somewhat knowledgeable with regard to the sensitivity of different terminology connected with the company's industry.

In further alternative embodiments incorporating local database functionality, there may also preferably be an internal function in the inventive document censor that gathers entries from the many different local databases. The gathered alternatives may then preferably be evaluated and considered for adding to the main alternative database.

Returning to the figures, FIG. 5 is a flowchart illustrating the preferred method and steps for implementing a preferred embodiment of the present invention. In step 500, the prohibited expressions are stored into a censor database. The target document is filtered in step 501 for each occurrence of the prohibited expressions. As the prohibited expressions are found in the target document, they are visibly marked at step 502, highlighting the prohibited expressions for the user. Step 503 shows storing the alternate expressions into the generalized database. Although step 503 is shown after step 502, both steps 500 and 503, which provide the storing of the censor terms and the alternates, may occur at the same time and/or preferably before the inventive document censor is used to actually censor a document. In step 504, groups of corresponding alternate expressions are preferably presented to the user for selectively replacing the prohibited expressions. Once the user selects the desired alternate expression, it preferably replaces the prohibited expression in step 505.

In addition to checking for sensitive terms and expressions as words and phrases, an alternative, preferred embodiment may also preferably check for sensitive terms and expressions as rules-based relationships between numbers, words, phrases, and the like. For example, a job description for a manager may have a goal set for reaching a certain percentage of growth or for reaching a sales quota of a certain amount. Such financial information may be sensitive to release in that revenues in certain areas or the need to raise revenues or growth in a certain area may reflect in some way, whether adverse or not, on the company. Therefore, rules may be defined in the censor database to highlight all occurrences of a percentage within predetermined number words of a numeric value e.g. 10 words. Thus, the phrase, “10% growth of an historic quarterly revenue of $10.6M,” would be highlighted by the inventive document censor.

Other rules would preferably be defined to highlight certain combinations of words while leaving individual occurrences in normal text. For example, by itself, “communication” does not necessarily suggest a sensitive area (e.g., “effective communication”). However, when paired with specific other terms such as electronic communication, wireless communication, satellite based communication, and the like, it may provide sensitive information if publicly released.

The rules could preferably be stored along with the other terms that comprise only singular words or phrases. Thus, the inventive document censor could preferably use the censor database to prompt for restricted terms and expressions as words, phrases, and rules-based relationships.

It should be noted that while the preferred embodiments disclosed in this application have described the inventive system and method as used as a document censor, the present invention is not so limited. In fact, the filtering capabilities of the inventive system may be used as a tool in any content- or knowledge-management system for storing and/or recomposing documents according to such management systems. For example, in a content-management system, the present invention may be used to filter the information from existing documents into categories and classifications of content or intelligence modules for storage on the content-management system. In addition to this front-end filtering, the present invention would also preferably be capable of assisting in the assembly or recomposition of selections of the content or knowledge modules stored on the content- or knowledge-management system.

What is claimed is:

1. A computerized document censor comprising:
a censor database of restricted terms;
a text comparator program for finding ones of said restricted terms in said document; and
a text highlighter program for highlighting said restricted terms found in said document.

2. The document censor of claim 1 further comprising:
a generalization database of non-restricted terms, wherein ones of said non-restricted terms correspond to ones of said restricted terms.

3. The document censor of claim 1 wherein said restricted terms comprise at least one of:
single words;
phrases; and
numbers.

4. The document censor of claim 1 wherein said text comparator program finds ones of said restricted terms via rules-based relationships.

5. The document censor of claim 1 wherein said non-restricted terms are gathered into said generalization database by a user.

6. The document censor of claim 2 wherein said censor provides alternative ones of said non-restricted terms to a user for selectively replacing said restricted terms found in said document.

7. The document censor of claim 2 further comprising:
a text editor for replacing said restricted terms found in said documents with selected ones of said non-restricted terms.

8. The document censor of claim 2 wherein said censor database and said generalization database are accessible by remote users.

9. A method for censoring a document comprising the steps of:
storing a list of prohibited expressions;
filtering said document to find ones of said prohibited expressions; and
visibly marking ones of said prohibited expressions found in said document.

10. The method of claim 9 further comprising the steps of:
storing a list of alternate expressions corresponding to said prohibited expressions;
and presenting a group of said alternative expressions corresponding to ones of said prohibited expressions found in said document.

11. The method of claim 9 wherein said storing said list of said prohibited expressions step comprises at least one of the steps of:
entering prohibited words;
entering prohibited phrases; and
entering rules of prohibited communication relationships.

12. The method of claim 10 wherein said storing said list of said alternate expressions step comprises at least one of the steps of:
entering alternate words;
entering alternate phrases; and
entering rules of alternate communication relationships.

13. The method of claim 10 further comprising the steps of:
selecting a corresponding alternate expression from said presented group of said alternate expressions; and
replacing said prohibited expression found in said document with said selected corresponding alternate expression.

14. The method of claim 9 wherein said storing said list of prohibited expressions is restricted to at least one predetermined administrator.

15. The method of claim 10 wherein said storing said list of alternate expressions is restricted to at least one predetermined administrator.

16. A computer program product having a computer readable medium having computer program logic recorded thereon for reviewing a document for restricted expressions comprising:
means for storing a list of said restricted expressions;
means for searching said document to find ones of said restricted expressions; and
means for visibly marking ones of said restricted expressions found in said document.

17. The computer program product of claim 16 further comprising:
means for storing a list of generalized expressions corresponding to said restricted expressions; and
means for presenting a group of said generalized expressions corresponding to ones of said restricted expressions found in said document.

18. The computer program product of claim 16 wherein said means for storing said list of said restricted expressions comprises at least one of:
means for entering restricted words;
means for entering restricted phrases; and
means for entering rules of restricted communication relationships.

19. The computer program product of claim 17 wherein said means for storing said list of said generalized expressions comprises at least one of:
means for entering generalized words;
means for entering generalized phrases; and
means for entering rules of generalized communication relationships.

20. The computer program product of claim 17 further comprising:
means for selecting a corresponding generalized expression from said presented group of said generalized expressions; and
means for replacing said restricted expression found in said document with said selected corresponding generalized expression.
